(19) United States
(12) Patent Application Publication
(10) Pub. No.: US 2004/0139770 A1
(43) Pub. Date: Jul. 22, 2004

(54) System and method for securing large trucks by securing the hydraulic power steering mechanism of truck

(76) Inventor: William E. Curl, Santa Clara, UT (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/756,221

(22) Filed: Jan. 12, 2004

Related U.S. Application Data
(60) Provisional application No. 60/439,141, filed on Jan. 10, 2003.
(60) Provisional application No. 60/443,304, filed on Jan. 28, 2003.

(51) Int. Cl. B60R 25/00; E05B 65/12

(52) U.S. Cl. 70/14; 70/253

(57) ABSTRACT

A locking system and method for securing an vehicle, particularly, a large truck, by means of a cover placed on the extended shaft of the power steering hydraulic cylinder of the vehicle, which is engaged with a clamp that can be locked on the cover by a locking mechanism preventing the hydraulic steering shaft from further retraction and thereby disabling the vehicle steering.

### RELATED APPLICATIONS

The present application relates to and claims priority from U.S. Provisional Application No. 60/439,141 filed Jan. 10, 2003 and U.S. Provisional Application No. 60/443,304 filed Jan. 28, 2003.

### BACKGROUND

Vehicle theft is a concern of many vehicle owners. Like other large investments, a vehicle must be protected from theft. The need to protect vehicles through the use of alarms, vehicle theft prevention devices, etc. is oftentimes a must in some regions of the world. Several techniques and devices have been employed in order to maintain the security of vehicles in this manner.

At the present time, there is the need for better protection of a vehicle, specifically, large trucks. Large trucks, in many cases are depended upon as the staple or livelihood of individuals, families, or businesses making them not only valuable but critical assets. In such cases the need to protect this asset can be extremely important. Large trucks used as means for transporting goods also can spend considerable amounts of time traveling from location to location where the safety of the vehicle in a particular region might not be known. These goods can require delivery or collection in almost any area imaginable compelling the trucks that transport such goods to be in those areas as well. This can make them vulnerable targets for theft.

Large trucks, particularly semi-trucks, often make frequent and extended stops to accommodate the drivers' need to sleep, rest, or recuperate while transporting cargo over long distances. This obviously places the trucks in a vulnerable situation because the operators can be weary and unable to stand guard against possible thieves. In order to prevent theft in situations such as this, an improved system and method for rendering such trucks inoperable and immobile while not in use is needed.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a perspective view of a lock system placed on a power steering hydraulic shaft according to one embodiment of the present invention.

FIG. 2 is a side view of lock system with a key lock according to one embodiment of the present invention.

FIG. 3 is a side view of lock system with a combination lock according to one embodiment of the present invention.

FIG. 4 is a flow chart according to one embodiment of the present invention.

FIG. 5 is a perspective view of a locking system placed on a large truck according to another embodiment of the present invention.

FIG. 6 is a perspective view of the locking system before placement on a vehicle according to one embodiment of the present invention.

FIG. 7 is an illustration of a truck with the locking system of FIG. 6 in place.

Throughout the drawings, identical reference numbers designate similar, but not necessarily identical, elements.

### DETAILED DESCRIPTION

This specification provides a system and method for decreasing or eliminating the possibility of vehicle theft, particularly theft of large trucks. In a first embodiment, a segmented cover is applied to a shaft of the power steering hydraulic cylinder of the vehicle along with a clamp and locking mechanism to disable the vehicle's steering and render the vehicle inoperable.

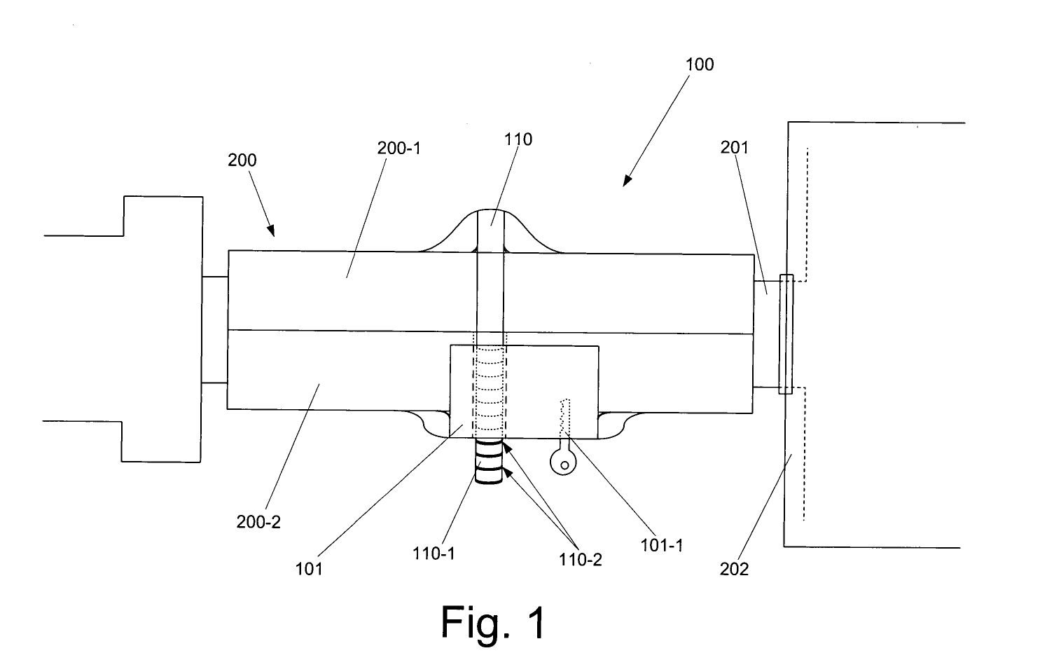

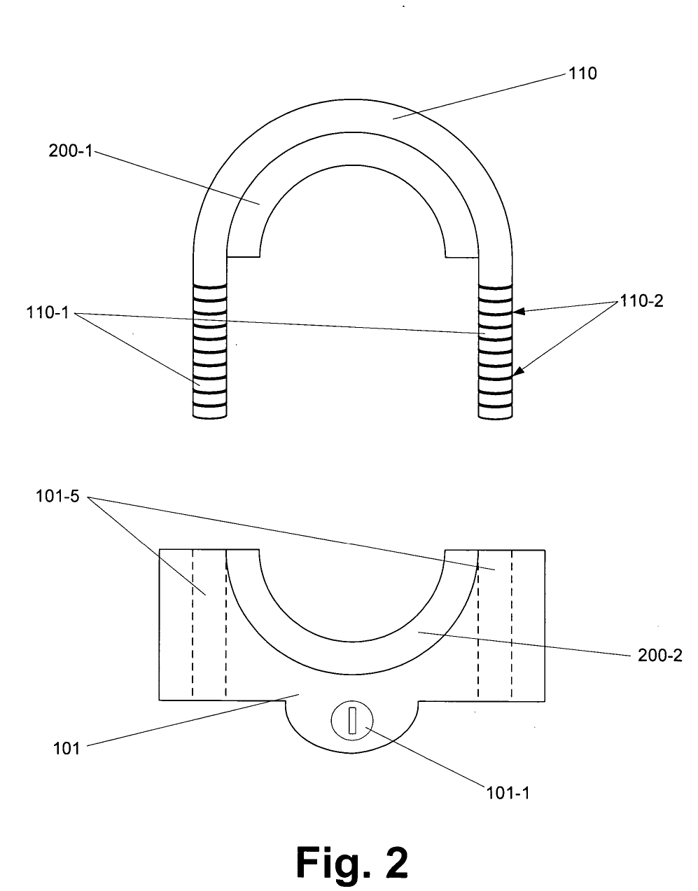

FIGS. 1 and 2 are depictions of one embodiment of the locking system (100). As shown in FIGS. 1 and 2, the locking system (100) consists of a segmented cover (200). A clamp (110) is connected to, or engages the segmented cover (200) and is secured in place by a locking mechanism (101).

The segmented cover (200) is separated into two parts such that it may be placed on the extended shaft (201) of the power steering hydraulic cylinder (202). The two pieces (200-1, 200-2) of the segmented cover may be hinged together. Also, the length of the segmented cover (200) is proportional to the length of the exposed portion of the extended shaft (201) of the power steering hydraulic cylinder (202) when the steering wheel of the vehicle is turned completely in either direction.

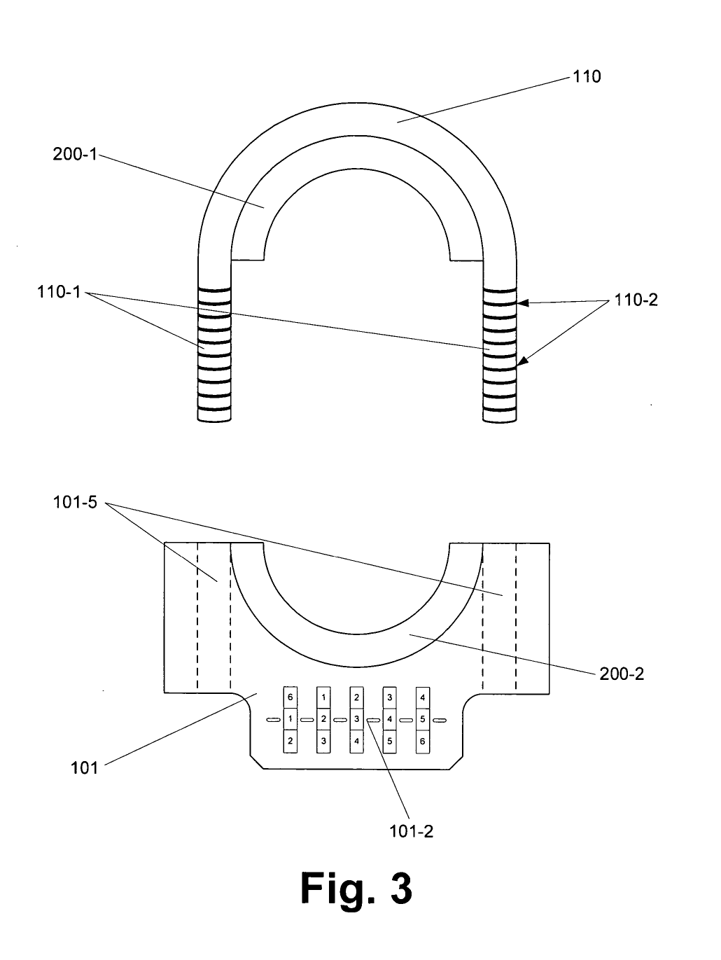

The two pieces of the segmented cover (200) of the lock system (100) are locked together when the lock system (100) is put in place. This is preferably accomplished by placing or engaging a clamp (110) around the segmented cover (200). As shown in FIGS. 2 and 3, the clamp (110) comprises a u-shaped section where the two extensions (110-1) of the u-shaped section are constructed to be engaged by the locking mechanism (101). Conversely, the locking mechanism (101) in part comprises two recesses (101-5) constructed to receive the extensions (110-1) of the clamp (110).

As shown in FIG. 1, the extensions (110-1) of the clamp (110) may consist of grooves (110-2) along their lengths that are mated by the locking mechanism (101) when the extensions (110-1) are appropriately placed in the recesses (101-5). As the extensions (110-1) are secured within the recesses (101-5), the clamp (110) and the locking mechanism (101) will encircle the segmented cover (200). When the locking mechanism (101) is so locked, the clamp (110) tightly engages the segmented cover (200), which in turn tightly engages the extended shaft (201) of the power steering hydraulic cylinder (202) such that the locking system (100) cannot be removed from the vehicle and will not allow it to be further steered.

The locking mechanism (101) can be, for example, a key lock (101-1) as depicted in FIGS. 1 and 2, a combination lock (101-2) as shown in FIG. 3, or other type of lock.

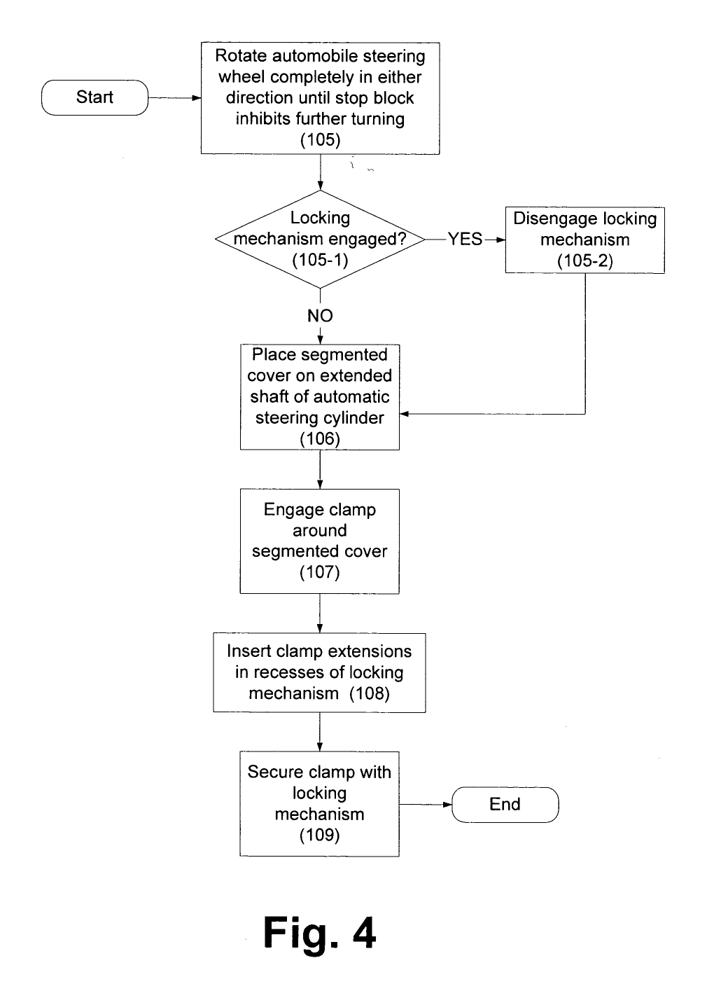

The method by which the locking system (100) is affixed to the vehicle as outlined by the flowchart in FIG. 4 is as follows: First, the steering wheel is turned completely to one side or the other until the stop block inhibits any further turning and the vehicle can only travel in a tight circle (105). With the steering wheel of the vehicle turned as described, a shaft (201) of the power steering hydraulic cylinder (202) will be fully extended.

Next, the locking mechanism (101) is disengaged (if engaged), allowing the segmented cover (200) to be separable into two parts (105-2). In this state the two pieces of the segmented cover (200) are placed on the extended shaft (201) so as to surround it (106).

When the segmented cover (200) is appropriately applied to the extended shaft (201) as described, the clamp (110) is placed to engage the segmented cover (200) (107). Next, the extensions (110-1) of the clamp (110) are placed in the recesses (101-5) of the locking mechanism (101) (108).

Finally, the extensions (110-1) of the clamp are prevented from further movement inside the recesses (101-5) of the locking mechanism (101) by means of engaging the locking mechanism (101) (109). If the vehicle is operated in this arrangement the vehicle can only move in a circle consistent with the locked position of the steering wheel.

The remainder of this specification provides another embodiment of a system and method for decreasing or eliminating the possibility of vehicle theft, particularly theft of large trucks. In this embodiment, a locking system is applied to a solid structure of the vehicle and a bracket connected to the control shaft of the power steering mechanism to disable the vehicle's steering and render the vehicle inoperable.

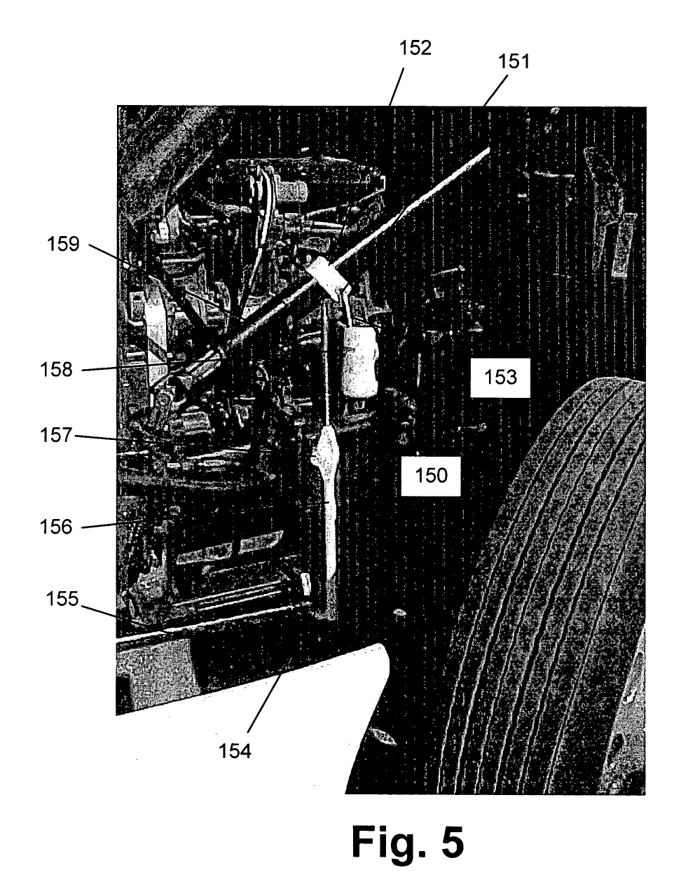

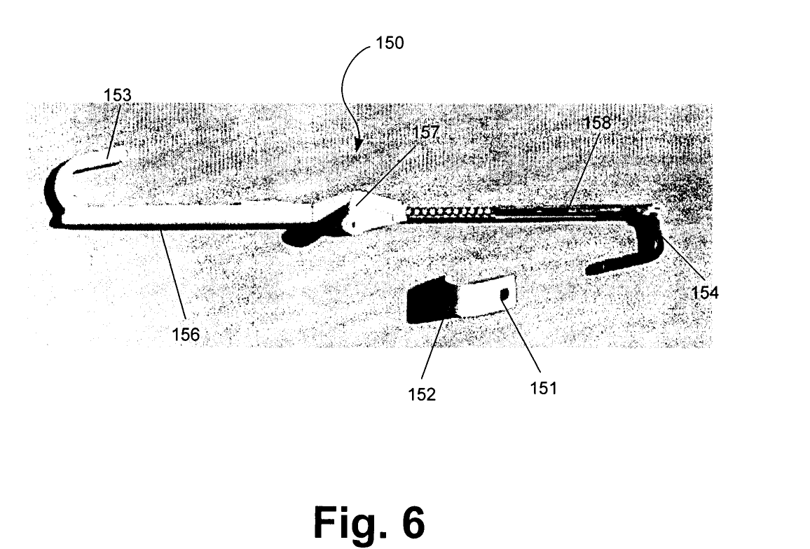

FIGS. 5 and 6 are depictions of one embodiment of the locking system (150). As shown in FIGS. 5 and 6, the locking system (150) consists of a hollow shaft (156). A hook (154) is connected to, or formed at, one end of the shaft (156). At the opposite end of the shaft (156) is a locking mechanism (157).

The locking mechanism (157) and the hollow shaft (156) are constructed to receive a connecting rod (158). One end of the connecting rod (158) can be inserted into the locking mechanism (157) and extends through the locking mechanism (157) into the hollow shaft (156). The other end of the connecting rod (158) has a bracket hook (153) for engaging a bracket (152). The bracket hook (153) is constructed to engage a bracket (152) by, for example, hooking though an opening (151) in the bracket (152) that is sized to receive the bracket hook (153). Each part of the locking system as described above is preferably constructed of a material that resists corrosion and can withstand wear and tear in order to allow the locking system to resist tampering of any kind.

The bracket (152) is welded, or secured by similar means, to the steering control shaft (159), shown in FIG. 5, of the vehicle. The hook (154) on the hollow shaft (156) is then hooked to, or engages, the lower steering arm (155) or other solid structure of the vehicle. The connecting rod (158) is then extended from the shaft (156) enough to allow the bracket hook (153) to be hooked into the bracket (152).

The locking mechanism (157) is then used to lock the connecting rod (158) into the shaft (156) so that the connecting rod (158) cannot slide with respect to the shaft (156). When the locking mechanism (157) is so locked, the bracket hook (153) and the shaft hook (154) will tightly engage the bracket (152) and the vehicle, respectively, such that the locking system (150) cannot be removed from the vehicle and will not allow the steering control shaft (159) to rotate.

The locking mechanism (157) can be, for example, a key lock as depicted in FIGS. 5 and 6, or a combination or other type of lock. The connecting rod (158) may have grooves along its length which can be engaged by the locking mechanism (157) so as to secure the connecting rod (158) at a particular position within the hollow shaft (156).

The vehicle cannot be steered without free movement of the steering control shaft (159). Consequently, by having the locking system (150) in place to prevent rotation of the steering control shaft (159), the vehicle cannot be operated by possible thieves.

The method by which the locking system (150) is affixed to the vehicle is as follows: First, the bracket (152) is attached to the power steering control shaft (159) of the vehicle by means of welding, a similar bonding method or other method. Next, the vehicle's steering wheel may be turned to a desired position in which the steering will be locked. This position preferably is when the steering wheel is turned completely to one side or the other until the stop block inhibits any further turning and the vehicle can only travel in a tight circle.

Next, the locking mechanism (157) is disengaged (if engaged), allowing the connecting rod (158) to move without restriction in the hollow shaft (156). In this state the shaft hook (154) is used to engage some solid structure of the vehicle, such as the lower steering arm (155). Likewise, the bracket hook (153) engages the welded bracket (152) by being inserted or hooked into the opening (151) on the bracket (152).

When both the bracket hook (153) and the shaft hook (154) are engaged as described, the connecting rod (158) is forced into the hollow shaft (156) as far as possible to minimize the overall length of the hollow shaft (156) and exposed connecting rod (158) between the bracket (152) and the lower steering arm (155) or other solid structure of the vehicle.

Finally, the connecting rod (158) is prevented from further movement inside the hollow shaft (156) by means of engaging the locking mechanism (157). If the vehicle is operated in this arrangement the vehicle can only move in a circle consistent with the locked position of the steering wheel.

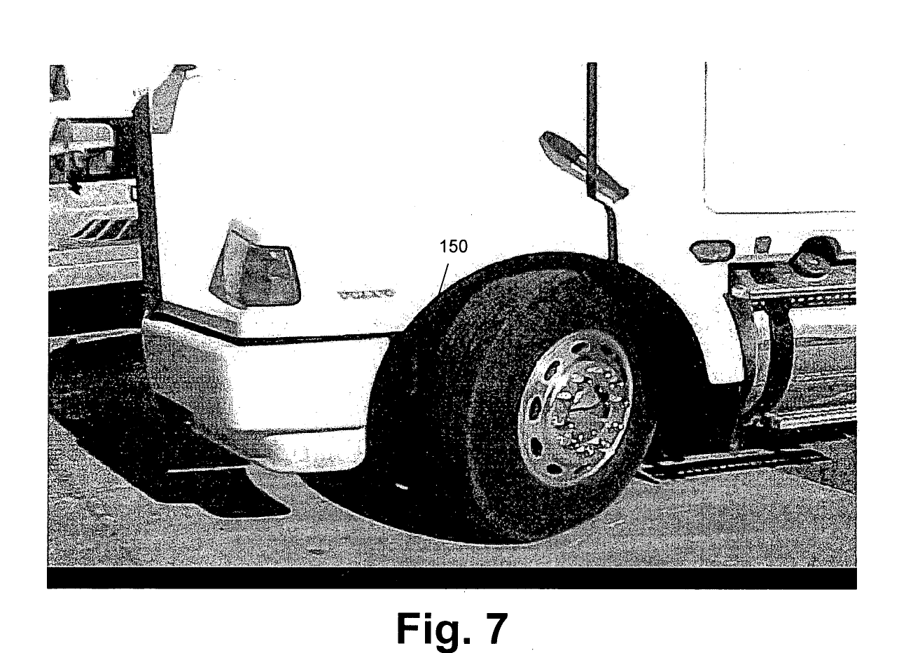

FIG. 7 illustrates that the locking mechanism will be visible next to the wheel of a secured vehicle when in place. This can deter prospective thieves who will then not even try to access or tamper with the secured vehicle.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

What is claimed is:

1. an vehicle anti-theft lock system comprising:
a segmented cover sized to removably engage an exposed portion of an extended shaft of an automatic power steering cylinder;
a clamp sized to engage said segmented cover;
a locking mechanism for locking said clamp in place around said segmented cover to lock said segmented cover to said shaft preventing said shaft from retracting.

2. The system of claim 1, wherein said segmented cover covers a length of said shaft when fully extended.

3. The system of claim 1, wherein said segmented cover comprises two pieces that are hinged together.

4. The system of claim 1, wherein said clamp has a u-shape.

5. The system of claim 1, wherein said locking mechanism is integrated into said segmented cover.

6. The system of claim 1, wherein said clamp is integrated into said segmented cover.

7. The system of claim 1, wherein said locking mechanism is a key lock.

8. The system of claim 1, wherein said locking mechanism is a combination lock.

9. A method of securing an vehicle comprising:
engaging a segmented cover to an exposed portion of an extended shaft of an automatic steering cylinder of said vehicle; and
securing said cover with a locking mechanism to lock said cover on said shaft.

10. An vehicle anti-theft locking system comprising:
a bracket permanently affixed to a steering control shaft of said vehicle a connecting rod having a hook for engaging said bracket;
a hollow shaft sized to receive an end of said connecting rod opposite of said hook;
a second hook at one end of said hollow shaft for engaging a solid structure of said vehicle; and
a locking mechanism on said hollow shaft for locking said connecting rod inside said hollow shaft.

11. The system of claim 10, wherein said solid structure is the lower steering arm of said vehicle.

12. The system of claim 10, wherein said locking mechanism comprises a key lock.

13. The system of claim 10, wherein said locking mechanism comprises a combination lock.

14. A method of securing a vehicle from theft, said method comprising physically preventing rotation of a steering control shaft of said vehicle with a locking system secured to said steering control shaft.

15. The method of claim 14, further comprising locking said locking system between said steering control shaft and a portion of said vehicle.

16. The method of claim 15, further comprising engaging said locking system between a bracket secured to said steering control shaft and said portion of said vehicle.

17. The method of claim 16, further comprising two hooks on said locking system, said method comprising engaging a first hook with said bracket and a second hook, with said portion of said vehicle.

18. The method of claim 17, further comprising locking said two hooks into a relative position when engaging said bracket and portion of said vehicle, respectively.
